(19) United States
(12) Patent Application Publication
(10) Pub. No.: US 2012/0199391 A1
(43) Pub. Date: Aug. 9, 2012

(54) ANTICORROSIVE, COATED ELECTRIC WIRE WITH TERMINAL, AND WIRING HARNESS

(75) Inventors: Masato Inoue, Yokkaichi-shi (JP); Hiroshi Sudou, Yokkaichi-shi (JP); Yukiyasu Sakamoto, Yokkaichi-shi (JP); Hiroshi Yamaguchi, Yokkaichi-shi (JP); Hisahiro Yasuda, Yokkaichi-shi (JP); Tetsuya Nakamura, Yokkaichi-shi (JP); Shigeyuki Tanaka, Yokkaichi-shi (JP); Naoya Nishimura, Yokkaichi-shi (JP); Daisuke Hashimoto, Yokkaichi-shi (JP); Yukou Sato, Yokkaichi-shi (JP)

(73) Assignees: AUTONETWORKS TECHNOLOGIES, LTD., YOKKAICHI-SHI, MIE (JP); SUMITOMO ELECTRIC INDUSTRIES, LTD., OSAKA-SHI, OSAKA (JP); SUMITOMO WIRING SYSTEMS, LTD., YOKKAICHI-SHI, MIE (JP)

(21) Appl. No.: 13/501,035

(22) PCT Filed: Nov. 10, 2010
(86) PCT No.: PCT/JP2010/070048

§ 371 Date: Apr. 9, 2012

(30) Foreign Application Priority Data
Nov. 12, 2009 (JP) 2009-258571

(51) Int. Cl. H02G 3/04; C09D 177/06; H01B 3/44

(52) U.S. Cl. 174/72 A; 174/110 SR; 524/606

(57) ABSTRACT

Provided is an anticorrosive that has an excellent coating property and excellent anticorrosive capability compared with a conventional anticorrosive. The anticorrosive mainly contains a thermoplastic polyamide resin, and has a tensile lap-shear strength of lapped aluminums of 6 N/mm² or more, which is measured in accordance with the JIS K6850, an elongation of 100% or more, which is measured in accordance with the ASTM D-1708, and a water absorption of 1.0% or less, which is measured in accordance with the JIS K7209. The anticorrosive is capable of being applied to an electrically connected portion between a wire conductor 18 of a coated electric wire 10 with a terminal and a terminal member 14.

### TECHNICAL FIELD

The present invention relates to an anticorrosive, a coated electric wire with a terminal, and a wiring harness, and more specifically relates to an anticorrosive that is favorably used to prevent corrosion at an electrically connected portion between a wire conductor and a terminal member, a coated electric Wire with a terminal using the anticorrosive, and a wiring harness using the anticorrosive.

### BACKGROUND ART

Conventionally, a coated electric wire, which is prepared by coating a wire conductor made of an annealed wire such as tough pitch copper with an insulation, is in widespread use as an electric wire used for wiring a car such as an automobile. A terminal member is connected to the wire conductor at an end of the coated electric wire, where the wire conductor is exposed by stripping off the insulation. The terminal member that is electrically connected to the end of the coated electric wire is inserted and locked into a connector.

A plurality of the coated electric wires with the terminals are bunched into a wiring harness. The coated electric wires in the form of wiring harness are used for wiring in a car such as an automobile.

Used for wiring in an engine room or a certain indoor environment that is subject to water, the wiring harness is susceptible to heat and water, so that rust is liable to form at electrically connected portions between the wire conductors and the terminal members. For this reason, it is necessary to prevent corrosion from building up at the electrically connected portions when the wiring harness is used in this environment. In order to prevent corrosion from building up at the electrically connected portion, PTL 1 discloses a technique to fill with grease the connectors into which the terminal members connected to the wire conductors are inserted and locked.

### CITATION LIST

### Patent Literature

PTL1: JP05-159846A

### SUMMARY OF INVENTION

### Technical Problem

These days, there are increasing tendencies to improve fuel efficiency by weight reduction of a car such as an automobile, and accordingly weight reduction of material for the electric wires that make up the wiring harness is demanded. For this reason, using aluminum for the wire conductors is considered.

Copper or a copper alloy that has excellent electric properties is generally used for the terminal members, and accordingly the aluminum electric wires and the copper terminal members are used in combination. However, when the wire conductors are different in material from the terminal members, bimetallic corrosion builds up at the electrically connected portions. This kind of corrosion builds up more easily compared with the case of using a same material for the wire conductors and the terminal members. For this reason, an anticorrosive is required, which can prevent corrosion from building up at the electrically connected portions in a convincing way.

However, the conventional grease is not capable of sufficiently preventing water immersion if it is not filled densely in the connectors. If the amount of grease filling is increased in order to enhance the anticorrosion effect, the grease is unintentionally coated on a portion where corrosion prevention is not needed. In addition, excessive filling makes the connectors and the electric wires sticky, which decreases handleability. In view of bimetallic corrosion, an anticorrosive having an excellent coating property and capable of delivering high anticorrosive capability that replaces the grease is required.

An object of the present invention is to provide an anticorrosive that has an excellent coating property and excellent anticorrosive capability compared with a conventional anticorrosive. Other objects are to provide a coated electric wire with a terminal using the anticorrosive, and to provide a wiring harness using the anticorrosive.

### Solution to Problem

In order to solve the problems described above, the anticorrosive of the present invention mainly contains a thermoplastic polyamide resin, and has a tensile lap-shear strength of lapped aluminums of 6 N/mm² or more, which is measured in accordance with the JIS K6850, an elongation of 100% or more, which is measured in accordance with the ASTM D-1708, and a water absorption of 1.0% or less, which is measured in accordance with the JIB K7209.

It is preferable that in the anticorrosive, the thermoplastic polyamide resin contains at least one of a dimer acid and a dicarboxylic acid, and a diamine.

It is preferable that the anticorrosive is used at an electrically connected portion between a wire conductor and a terminal member.

In another aspect of the present invention, a coated electric wire with a terminal includes a wire conductor and a terminal member, wherein an electrically connected portion between the wire conductor and the terminal member is coated with the anticorrosive.

It is preferable that in the coated electric wire with the terminal, the wire conductor includes elemental wires made of aluminum or an aluminum alloy, and the terminal member is made of copper or a copper alloy.

Yet, in another aspect of the present invention, a wiring harness includes the coated electric wire with the terminal.

### Advantageous Effects of Invention

Mainly containing the thermoplastic polyamide resin, the anticorrosive of the present invention has an excellent coating property compared with grease. Having the physical properties of tensile lap-shear strength, elongation and water absorption that fall within the respective specific ranges, the anticorrosive of the present invention has excellent anticorrosive capability.

If the thermoplastic polyamide resin contains at least one of the dimer acid and the dicarboxylic acid, and the diamine, a harmonious balance can be maintained among the physical properties of tensile lap-shear strength, elongation, water absorption and melt viscosity which allows the anticorrosive to have the coating property and the anticorrosive capability that are well balanced.

If the anticorrosive is used at the electrically connected portion between the wire conductor and the terminal member, the electrically connected portion has improved anticorrosive capability, which allows the electrically connected portion to have increased connecting reliability.

Having the configuration that the electrically connected portion between the wire conductor and the terminal member is coated with the anticorrosive, the coated electric wire of the present invention has the electrically connected portion that has improved anticorrosive capability, which allows the electrically connected portion to have increased connecting reliability.

If the wire conductor includes the elemental wires made of aluminum or an aluminum alloy and the terminal member is made of copper or a copper alloy, which establishes bimetallic connection, full use of the effect of the anticorrosive of the present invention can be made.

The wiring harness of the present invention includes the coated electric wire that has improved anticorrosive capability. Thus, the wiring harness can be used favorably for wiring in an engine room or a certain indoor environment that is subject to water.

### BRIEF DESCRIPTION OF DRAWINGS

FIG. 1 is a view showing a coated electric wire with a terminal of a first preferred embodiment of the present invention.

FIG. 2 is a cross-sectional view showing the same along the line A-A of FIG. 1.

FIG. 3 is a view for illustrating a corrosion test.

### DESCRIPTION OF EMBODIMENTS

Detailed descriptions of an anticorrosive of preferred embodiments of the present invention (hereinafter, referred to also as the “present anticorrosive”), a coated electric wire with a terminal of preferred embodiments of the present invention (hereinafter, referred to also as the “present coated electric wire”), and a wiring harness of preferred embodiments of the present invention (hereinafter, referred to also as the “present wiring harness”) will now be provided.

1. Present Anticorrosive

The present anticorrosive mainly contains a thermoplastic polyamide resin. The thermoplastic polyamide resin preferably contains at least one of a dimer acid and a dicarboxylic acid, and a diamine. This is because a harmonious balance can be maintained among physical properties such as tensile lap-shear strength, elongation, water absorption and melt viscosity of the anticorrosive, which allows the anticorrosive to have a coating property and an anticorrosive capability that are well balanced.

It is preferable that the present anticorrosive contains a single kind of a thermoplastic polyamide resin, or it is preferable that the present anticorrosive contains two or more different kinds of thermoplastic polyamide resins. Further, it is preferable that the present anticorrosive contains an additive and another polymer as appropriate within a range of not impairing its physical properties.

The additive described above is not limited specifically as long as it defines an additive that can be generally used for a material for resin molding. To be specific, examples of the additive include an inorganic filler, an antioxidant, a metal deactivator (a copper inhibitor), an ultraviolet absorber, an ultraviolet-concealing agent, a flame-retardant auxiliary agent, a processing aid (e.g., a lubricant, wax), and carbon and other coloring pigments.

It is preferable that the present anticorrosive is cross-linked as appropriate in order to increase heat resistance and mechanical strength. Examples of a method for the crosslinking include a thermal crosslinking method, a chemical crosslinking method, a silane crosslinking method, an electron irradiation crosslinking method, and an ultraviolet crosslinking method, which are not limited specifically. The present anticorrosive is preferably cross-linked after an anticorrosive treatment using the present anticorrosive is performed.

The anticorrosive has a tensile lap-shear strength of lapped aluminums of 6 N/mm² or more, which is measured in accordance with the JIS K6850. It is to be noted that the JIS K6850 (“Adhesives-Determination of tensile lap-shear strength of rigid-to-rigid bonded assemblies”) stipulates determination of tensile lap-shear strength of rigid-to-rigid bonded assemblies by using a standard test specimen under specified adjustment and test conditions. In the present invention, aluminum boards are used as the rigid-to-rigid bonded assemblies and the present anticorrosive is used as a bonding layer sandwiched by the aluminum boards, and thus a test specimen is prepared.

If the tensile lap-shear strength of lapped aluminums is less than 6 N/mm², it is difficult to bring the anticorrosive, even melted, into intimate contact with a portion where corrosion prevention is needed such as an electrically connected portion between a wire conductor and a terminal member. Therefore, it is difficult for the anticorrosive to obtain a high anticorrosion effect. The tensile lap-shear strength of lapped aluminums is preferably 7 N/mm² or more, and more preferably 8 N/mm² or more. The upper limit of the tensile lap-shear strength of lapped aluminums is not limited specifically because it is preferable that the present anticorrosive has sufficient adhesion.

The anticorrosive has an elongation (at normal temperature of 24 degrees C.) of 100% or more, which is measured in accordance with the ASTM D-1708.

If the elongation is less than 100%, a shrinkage crack is produced in the anticorrosive when the anticorrosive is cooled and hardened after melted and applied on the portion where corrosion prevention is needed such as the electrically connected portion between the wire conductor and the terminal member. Due to this, water is immersed into the crack, so that it is difficult for the anticorrosive to obtain a high anticorrosion effect. The elongation is preferably 150% or more, and more preferably 200% or more. The upper limit of the elongation is not limited specifically because it is preferable that the present anticorrosive has a sufficient elongation.

The anticorrosive has a water absorption of 1.0% or less, which is measured in accordance with the JIS K7209. The water absorption defines a value that is measured in an A-method under the conditions that an immersion period is 7 days, and the shape of test specimen is a sheet shape.

If the water absorption is more than 1.0%, the anticorrosive is liable to absorb water depending on use environment thereof such as car environment. Therefore, it is difficult for the anticorrosive to obtain a high anticorrosion effect. The water absorption is preferably 0.8% or less, and more preferably 0.5% or less . The lower limit of the water absorption is not limited specifically because it is preferable that the present anticorrosive has a lower water absorption.

For example, the present anticorrosive is favorably used to prevent corrosion from building up at an electrically connected portion between a wire conductor and a terminal member that are used for wiring in a car such as an automobile.

2. Present Coated Electric Wire

Next, a description of the present coated electric wire is provided.

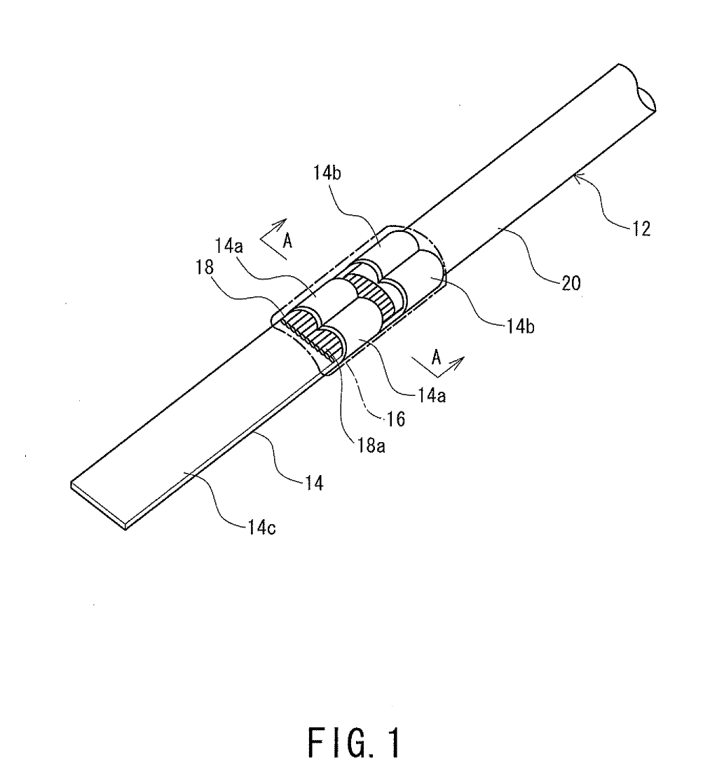

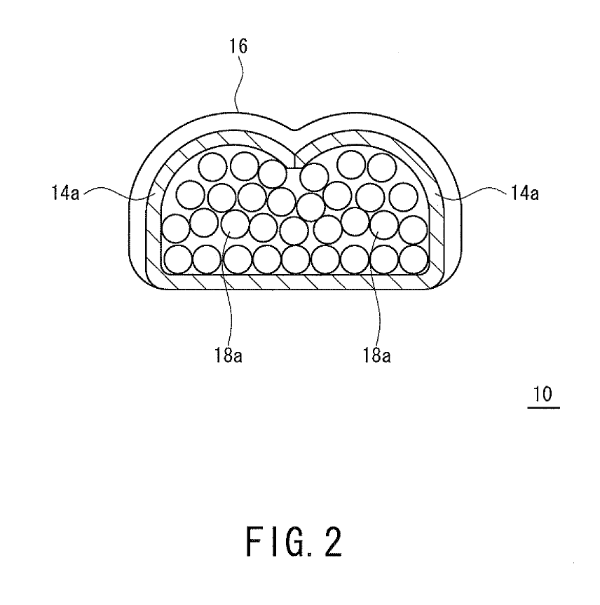

A present coated electric wire 10 includes a coated electric wire 12 including a wire conductor 18 and an insulation 20 with which the wire conductor 18 is coated, and a terminal member 14 connected to an end of the wire conductor 18 of the coated electric wire 12, as shown in FIGS. 1 and 2.

The insulation 20 is peeled off at the end of the wire conductor 18 of the coated electric wire 12, so that the wire conductor 18 is exposed at the end. The terminal member 14 is connected to the exposed end of the wire conductor 18. The wire conductor 18 defines a strand made up of a plurality of elemental wires 18a. In this case, the strand may be made up of metallic elemental wires of one kind, or may be made up of metallic elemental wires of two or more than two kinds. The strand may include an elemental wire made of an organic fiber in addition to the metallic elemental wires. It is to be noted that the metallic elemental wires of one kind define that all the metallic elemental wires of the strand are made of a same metallic material, and the metallic elemental wires of two or more than two kinds define that the metallic elemental wires made of different metallic materials are included in the strand. The strand may include also a reinforcement wire (tension member) for reinforcing the coated electric wire 12.

The metallic elemental wires are made preferably of copper, a copper alloy, aluminum, an aluminum alloy, or one of these materials that are plated with different kinds of materials. An elemental wire that is defined as the reinforcement wire is made preferably of a copper alloy, titanium, tungsten or stainless steel. An elemental wire that is defined as the organic fiber is made preferably of KEVLAR.

The insulation 20 is made preferably from rubber, polyolefin, PVC or a thermoplastic elastomer, which may be used singly or in combination. The insulation 20 may contain a variety of additives such as a flame retardant, a filler, and a coloring agent, as appropriate.

The terminal member 14 includes a connecting portion 14c having the shape of a tub and arranged to be connected to a counterpart terminal, wire barrels 14a extending from a base end of the connecting portion 14c and crimped onto the end of the wire conductor 18 of the electric wire 12, and insulation barrels 14b extending from the wire barrels 14a and crimped onto the insulation 20 at the end of the coated electric wire 12.

The terminal member 14 (a base member thereof) is made preferably of general brass, a variety of copper alloys and copper. It is preferable to plate a partial surface (e.g., a connecting point) or an entire surface of the terminal member 14 with a variety of metals such as tin, nickel and gold.

A portion of the wire conductor 18 is exposed at an electrically connected portion between the wire conductor 18 and the terminal member 14. In the present coated electric wire 10, the exposed portion is coated with the anticorrosive described above. To be specific, a coating film 16 of the anticorrosive lies over from the base end of the connecting portion 14c while striding over the border between the base end of the connecting portion 14c of the terminal member 14 and the end of the wire conductor 18 until the insulation 20 while striding over the border between the insulation barrels 14b of the terminal member 14 and the insulation 20.

The anticorrosive to be used has the physical properties within the range described above, considering the combination of the material of the wire conductor 18 and the material of the terminal member 14. The thickness of the coating film 16 of the anticorrosive is adjusted as appropriate; however, the thickness is preferably from 0.01 mm to 0.1 mm. If the thickness of the coating film 16 is too large, it is difficult for the terminal member 14 to be inserted into a connector. On the other hand, if the thickness of the coating film 16 is too small, the anticorrosion effect is liable to lessened.

After crimping the terminal member 14 onto the end of the coated electric wire 12 to connect the wire conductor 18 and the terminal member 14, the anticorrosive is coated on a surface of the connected portion between the wire conductor 18 and the terminal member 14, that is, a surface at the end of the insulation 20, surfaces of the insulation barrels 14b, surfaces of the wire barrels 14a, a surface of the exposed wire conductor 18, and a surface of the base end of the connecting portion 14c. Thus, the coating film 16 is formed on the surface of the connected portion between the wire conductor 18 and the terminal member 14.

It is also preferable to form a coating film 16 on a back surface of the tub-shaped connecting portion 14c extending from the wire barrels 14a of the terminal member 14, back surfaces of the wire barrels 14a, and back surfaces of the insulation barrels 14b if the formed coating film 16 does not impair the electrical connection.

In applying the anticorrosive, it is essential only that the anticorrosive should flow to the extent of being coatable. Thus, in applying the anticorrosive, it is preferable to heat it as appropriate, or to fluidify it using a solvent as appropriate. The application of the anticorrosive is performed preferably in a falling-drop method, a coating method, or an extrusion method. A heating temperature for the anticorrosive is preferably 150 to 250 degrees C.

It is preferable that the coating film 16 is cross-linked as appropriate in order to increase heat resistance and mechanical strength. Examples of a method for the crosslinking include a thermal crosslinking method, a chemical crosslinking method, a silane crosslinking method, an electron irradiation crosslinking method, and an ultraviolet crosslinking method, which are not limited specifically.

Mainly containing the thermoplastic polyamide resin, the anticorrosive demonstrates fluidity by heating. For this reason, the anticorrosive has an easy-to-apply property, which allows the anticorrosive to be applied to an intended site with precision in a convincing way. For example, even in a case where the coated electric wire 12 is small in diameter (e.g., 0.8mm) and the terminal member 14 is small in width (e.g., 0.64 mm at the tub), the anticorrosive can be tightly targeted and applied only at the electrically connected portion between the wire conductor 18 and the terminal member 14 with precision in a convincing way.

In addition, being cooled and hardened after the application, the anticorrosive is not sticky at the time of handling, and can be fixed to the applied site over a long period of time. Thus, the anticorrosion effect can be sustained over a long period of time.

3. Present Wiring Harness

A plurality of coated electric wires with terminals including the present coated electric wire 10 are bunched into the present wiring harness. In the present wiring harness, some of the included coated electric wires may be the present coated electric wires 10, or all of the included coated electric wires may be the present coated electric wires 10.

In the present wiring harness, the coated electric wires may be bound with tape, or may be armored with an armoring member such as a circular tube, a corrugated tube and a protector.

The present wiring harness is favorably used for wiring in a car such as an automobile, especially for wiring in an engine room or the interior of a car that is subject to water. These sites are susceptible to heat and water, so that when a wiring harness is used for wiring in these sites, rust is liable to format the electrically connected portion between the wire conductor 18 and the terminal member 14. However, using the present wiring harness can effectively prevent rust from forming at the electrically connected port ion between the wire conductor 18 and the terminal member 14.

### EXAMPLE

A description of the present invention will now be specifically provided with reference to Examples. It is to be noted that the present invention is not limited to Examples.

1. Preparation of Coated Electric Wire

A polyvinyl chloride composition was prepared as follows: 100 parts by mass of polyvinyl chloride (polymerization degree of 1300) was mixed with 40 parts by mass of diisononyl phthalate that defines a. plasticizer, 20 parts by mass of calcium carbonate heavy that defines a filler, and 5 parts by mass of a calcium-zinc stabilizer that defines a stabilizer at 180 degrees C. in an open roll, and the mixture was formed into pellets with the use of pelletizer.

Then, a conductor (having a cross-sectional area of 0.75 mm) that defines an aluminum alloy strand that is made up of seven aluminum alloy wires was extrusion-coated with the polyvinyl chloride composition prepared as above such that the coat has a thickness of 0.28 mm. Thus, a coated electric wire (PVC electric wire) was prepared.

2. Preparation of Coated Electric Wire with Terminal

By using a plurality of the coated electric wires prepared as above, a coated electric wire with a terminal was prepared as follows. The coat was peeled off at an end of each coated electric wire to expose each wire conductor, and then a male crimping terminal member (0.64 mm in width at a tub) made of brass generally used for automobile was crimped onto the end of each coated electric wire.

Then, one of anticorrosives of different kinds to be described later was applied to an electrically connected portion between the wire conductors and the terminal member, and thus the exposed wire conductors and barrels of the terminal member were coated with the anticorrosive. In this manner, the plurality of coated electric wires with the terminals, of which the connected portions were coated with the anticorrosives of different kinds, were prepared. It is to be noted that the anticorrosives were heated to 230 degrees C. to fluidify, and applied such that the coats have a thickness of 0.05 mm.

### Example 1

Thermoplastic polyamide resin (A) [manuf.: HENKEL JAPAN LTD., “MACROMELT (a registered trade mark) 6801”]

### Example 2

Thermoplastic polyamide resin (B) [manuf.: HENKEL JAPAN LTD., “MACROMELT (a registered trade mark) JP116”]

### Example 3

Thermoplastic polyamide resin (C) [manuf.: HENKEL JAPAN LTD., “MACROMELT (a registered trade mark) 6301”]

### Comparative Example 1

Thermoplastic polyamide resin (a) [manuf.: HENKEL JAPAN LTD., “MACROMELT (a registered trade mark) 6217”]

### Comparative Example 2

Thermoplastic polyamide resin (b) [manuf.: HENKEL JAPAN LTD., “MACROMELT (a registered trade mark) 6030”]

### Comparative Example 3

Thermoplastic polyamide resin (c) [manuf.: HENKEL JAPAN LTD., “MACROMELT (a registered trade mark) 6880”]

3. Evaluation Procedure

Evaluations of anticorrosive capability of the anticorrosives of different kinds were performed on the coated electric wires with the terminals that were coated with the anticorrosives by detecting the presence or absence of a crack formed in the anticorrosives.

(Crack)

After coated with the anticorrosives of different kinds, the coated electric wires with the terminals were left in the air for one day, and the detection of the presence or absence of a crack formed in the anticorrosives was performed with eyes by using a microscope. The coated electric wires with the terminals in which cracks were absent in the anticorrosives were evaluated as PASSED. The coated electric wires with the terminals in which cracks were present in the anticorrosives were evaluated as FAILED.

(Anticorrosive Capability)

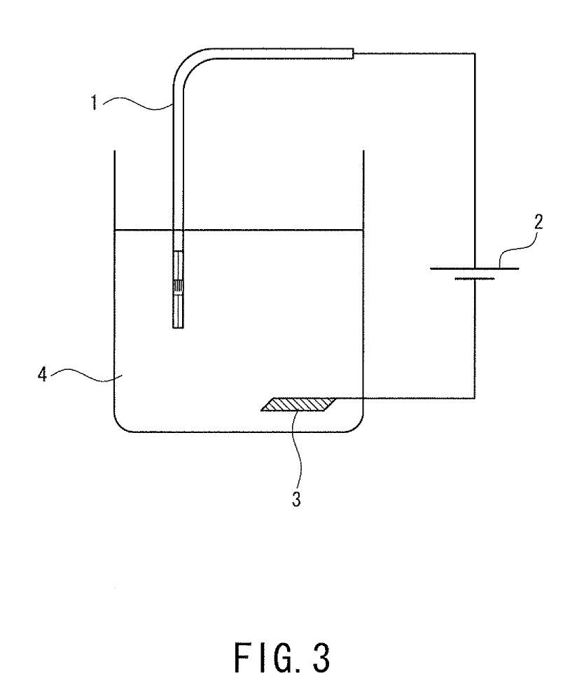

As shown in FIG. 3, each of the prepared coated electric wires 1 with the terminals was connected to a positive electrode of an electrical power source of 12 volts, while a pure copper plate 3 (1 cm in width×2 cm in length×1 mm in thickness) was connected to a negative electrode of the electrical power source of 12 volts. The pure copper plate 3 and each of the electrically connected portions between the wire conductors of the coated electric wires 1 and the terminal members were immersed in 300 cc of a water solution 4 containing 5% of NaCl, and a voltage of 12 volts was applied thereto. After the application of the voltage, ICP emission analysis of the water solution 4 was performed to measure the amounts of aluminum ions eluted from the wire conductors of the coated electric wires 1 with the terminals. The coated electric wires with the terminals in which the amounts of aluminum ions eluted from the wire conductors were less than 0.1 ppm were evaluated as PASSED. The coated electric wires with the terminals in which the amounts of aluminum ions eluted from the wire conductors were 0.1 ppm or more were evaluated as FAILED.

Tensile lap-shear strengths of lapped aluminums of the anticorrosives of Examples and Comparative Examples, which were measured in accordance with the JIS K6850, elongations (at normal temperature of 24 degrees C.) of the anticorrosives of Examples and Comparative Examples, which were measured in accordance with the ASTM D-1708, and water absorptions of the anticorrosives of Examples and Comparative Examples, which were measured in accordance with the JIS K7209 (A-method under the conditions that an immersion period is 7 days, the shape of test specimens is a sheet shape), and evaluation results of the anticorrosives of Examples and Comparative Examples are presented in Table 1.

TABLE 1

| | | | | | Comparative | Comparative | Comparative |
|---|---|---|---|---|---|---|---|
| | | Example 1 | Example 2 | Example 3 | Example 1 | Example 2 | Example 3 |
| Tensile lap-shear strength (Al/Al) | (N/mm2) | 10.8 | 10.8 | 6.7 | 2.1 | 4.4 | 3.4 |
| Elongation | (%) | 1000 | 780 | 840 | 120 | 20 | 96 |
| Water absorption (7 days) | (%) | 0.78 | 0.89 | 0.43 | 1.5 | 0.23 | 2.34 |

| | | | | | | |
|---|---|---|---|---|---|---|
| Crack | PASSED | PASSED | PASSED | PASSED | FAILED | FAILED |
| Anticorrosive capability | PASSED | PASSED | PASSED | FAILED | FAILED | FAILED |

As is evident from Table 1, the anticorrosive of Comparative Example 1, of which the tensile lap-shear strength and the water absorption fall outside the ranges defined by the present invention, is insufficient in adhesion, liable to absorb water, and inferior in anticorrosive capability.

The anticorrosive of Comparative Example 2, of which the tensile lap-shear strength and the elongation fall outside the ranges defined by the present invention, is insufficient in adhesion, and inferior in anticorrosive capability because water is immersed into a formed crack.

The anticorrosive of Comparative Example 3, of which the tensile lap-shear strength, the elongation and the water absorption fall outside the ranges defined by the present invention, is insufficient in adhesion, liable to absorb water, and inferior in anticorrosive capability because water is immersed into a formed crack.

Meanwhile, the anticorrosives of the present invention, of which the tensile lap-shear strength, the elongation and the water absorption fall within the ranges defined by the present invention, have sufficient adhesion to the electrically connected portions, and can prevent water immersion. In addition the anticorrosives of the present invention are excellent in coating property compared with grease. In addition, a shrinkage crack is seldom produced in the anticorrosives of the invention after the application. Thus, the anticorrosives of the present invention are capable of delivering high anticorrosive capability.

The foregoing description of the preferred embodiments of the present invention has been presented for purposes of illustration and description; however, it is not intended to be exhaustive or to limit the present invention to the precise form disclosed, and modifications and variations are possible as long as they do not deviate from the principles of the present invention.

For example, though the coated electric wire 10 has the configuration of including the male terminal including the tub-shaped connecting portion 14c, which defines the terminal member 14, the present invention is not limited to this configuration. It is also preferable that a female terminal capable of fitting into a male terminal, or a tuning-fork terminal is used as the terminal member 14. In addition, it is also preferable that the terminal member 14 does not include the insulation barrels 14b, and the crimp is performed only by the wire barrels 14a. In addition, the method for connecting the wire conductor 12 and the terminal member 14 is not limited to the crimp using the barrels, and it is also preferable that the wire conductor 12 and the terminal member 14 are connected by a method such as pressure-resistance welding, ultrasonic welding and soldering. In addition, though the conductor 18 defines a strand in the preferred embodiments, it is preferable that the conductor 18 defines a single wire.

1. An anticorrosive that mainly contains a thermoplastic polyamide resin, and has
a tensile lap-shear strength of lapped aluminums of 6 N/mm² or more, which is measured in accordance with the JIS K6850;
an elongation of 100% or more, which is measured in accordance with the ASTM D-1708; and
a water absorption of 1.0% or less, which is measured in accordance with the JIS K7209.

2. The anticorrosive according to claim 1, wherein the thermoplastic polyamide resin contains:
at least one of a dimer acid and a dicarboxylic acid; and
a diamine.

3. The anticorrosive according to claim 2, used at an electrically connected portion between a wire conductor and a terminal member.

4. A coated electric wire with a terminal, the electric wire comprising a wire conductor and a terminal member, wherein an electrically connected portion between the wire conductor and the terminal member is coated with the anticorrosive according to claim 3.

5. The coated electric wire with the terminal according to claim 4, wherein the wire conductor comprises elemental wires made of aluminum or an aluminum alloy, and the terminal member is made of copper or a copper alloy.

6. A wiring harness comprising the coated electric wire with the terminal according to claim 5.

7. A wiring harness comprising the coated electric wire with the terminal according to claim 4.

8. A coated electric wire with a terminal, the electric wire comprising a wire conductor and a terminal member, wherein an electrically connected portion between the wire conductor and the terminal member is coated with the anticorrosive according to claim 2.

9. The anticorrosive according to claim 1, used at an electrically connected portion between a wire conductor and a terminal member.

10. A coated electric wire with a terminal, the electric wire comprising a wire conductor and a terminal member, wherein an electrically connected portion between the wire conductor and the terminal member is coated with the anticorrosive according to claim 1.
